(19) United States
(12) Patent Application Publication
(10) Pub. No.: US 2005/0153727 A1
(43) Pub. Date: Jul. 14, 2005

(54) Wireless communication device arrangement

(75) Inventor: Chiu K. Li, San Diego, CA (US)

Correspondence Address: Kyocera Wireless Corp., P. O. Box 928289, San Diego, CA, 92129-8289, US

(73) Assignee: KYOCERA WIRELESS CORP., San Diego, CA (US)

(21) Appl. No.: 10/756,941

(22) Filed: Jan. 13, 2004

(51) Int. Cl. H04M 1/00

(52) U.S. Cl. 455/550.1; 455/90.3

(57) ABSTRACT

An exemplary wireless communication device comprises a housing having a front surface, a first side surface, and a second side surface, wherein the second side surface is situated opposite the first side surface of the housing. An antenna is situated proximate the first side surface, and a speaker and a microphone are situated proximate the second side surface of the housing, which results in increased distance and EM interference between the user's head and the antenna during conversational use of the wireless communication device.

### BACKGROUND OF THE INVENTION

1. Field of the Invention

The present invention relates to the field of communication devices. More specifically, the invention relates to wireless communication devices.

2. Related Art

A typical wireless communication device, such as a mobile phone, comprises, among other things, a processor coupled to a memory and to a transceiver, each of which is mounted on a printed circuit board (“PCB”) and enclosed in a housing. A mobile power source, such as a battery, is coupled to and supplies power to the processor, the memory and the transceiver. A speaker and a microphone are also enclosed within the housing for transmitting and receiving, respectively, acoustic signals to and from a user of the wireless communication device. The wireless communication device communicates information by transmitting and receiving electromagnetic (“EM”) energy in the radio frequency (“RF”) band via an antenna coupled to the transceiver.

In a conventional wireless communication device arrangement, the front surface of the housing includes a number of holes for interfacing various components, e.g., a keypad, a display device, a speaker and a microphone, to the user. More typically, the holes for the speaker and microphone are aligned approximately along a center vertical axis on the front surface of the housing. With this conventional arrangement, a user holds the front surface of the wireless communication device against the user's head while speaking into the microphone and listening to audio generated by the speaker, i.e., during conversational use.

A significant problem with the conventional arrangement described above, however, is the increased EM interference between the user's head and the antenna, which is generally mounted on the top surface of the housing and in close proximity the user's head. Depending on the degree of EM interference, the RF performance of the wireless communication device can be significantly degraded and/or may not meet government regulations regarding wireless communications. Another source of EM energy are the electrical signals operating at high frequencies on the PCB, the display device, or other device incorporated into the wireless communication device. Depending on the components and layout of a PCB, for example, a high concentration of EM energy may be generated from one or more localized area of the PCB.

Known attempts for reducing the EM interference between the user's head and the wireless communication device generally comprise three types, each of which is associated with a number of disadvantages. Shielding techniques employ a metal plate connected to ground and arranged between the user and the antenna and/or the PCB for relocating or spreading the EM energy generated by the antenna and/or the PCB. The shielding approach, however, increases the number of elements in the wireless communication device, resulting in significantly increased manufacturing costs. Moreover, many shielding techniques are not very effective or otherwise consume substantial amount of experimentation and testing to achieve requisite EM relocation or spreading, which are undesirable.

RF absorption techniques employ a RF absorbing material arranged between the user and the antenna and/or the PCB for absorbing the EM energy generated by the antenna and/or the PCB and converting the absorbed EM energy, e.g., into heat. This loss of EM energy, however, results in reduced device performance and increased power consumption. Furthermore, like the shielding approach, RF absorption increases the number of elements in the wireless communication device, resulting in significantly increased manufacturing costs.

Another technique employs modifying the antenna structure and/or the transmission power to reduce the gain of the wireless communication device. Reduced gain, however, negatively results in reduced RF performance. Additionally, modifying the antenna structure results in increased development and design costs, as well as increased manufacturing costs. In some cases, modifying the antenna structure results in increased form-factor of the wireless communication device which is also undesirable.

### SUMMARY OF THE INVENTION

A wireless communication device arrangement is disclosed which addresses and resolves one or more of the disadvantages associated with conventional wireless communication device arrangements, as discussed above.

By way of illustration, an exemplary wireless communication device comprises a housing having a front surface, a first side surface, and a second side surface. The second side surface is situated opposite the first side surface of the housing. The wireless communication device further includes an antenna situated proximate the first side surface. On the second side surface are defined first and second openings, such as a speaker opening and a microphone opening. A speaker situated within the housing transmits acoustic signals via the speaker opening, and a microphone situated within the housing receives acoustic signals via the microphone opening. With this arrangement, the user places the second side surface, rather than the front surface, against or proximate the user's head to speak into the microphone and to hear audio generated by the speaker. Advantageously, the distance between the user's head and the antenna is effectively increased, resulting in significantly reduced EM interference.

According to various embodiments, one or more of benefits may be realized by the wireless communication device arrangement including, for example, reduced device complexity, reduced device design and development time, reduced manufacturing costs, reduced hearing aid interference, improved hearing aid compatibility, improved device performance, and improved power consumption efficiency, among others, as discussed in greater detail below.

Other features and advantages of the present invention will become more readily apparent to those of ordinary skill in the art after reviewing the following detailed description and accompanying drawings.

### BRIEF DESCRIPTION OF THE DRAWINGS

FIG. 1A illustrates a front perspective view of an exemplary wireless communication device according to one embodiment of the present invention.

FIG. 1B illustrates a rear perspective view of the exemplary wireless communication device of FIG. 1A.

FIG. 2 illustrates a cross-sectional view of an exemplary wireless communication device according to one embodiment of the present invention.

FIG. 3 illustrates a front elevation view of an exemplary wireless communication device according to one embodiment of the present invention.

### DETAILED DESCRIPTION OF THE INVENTION

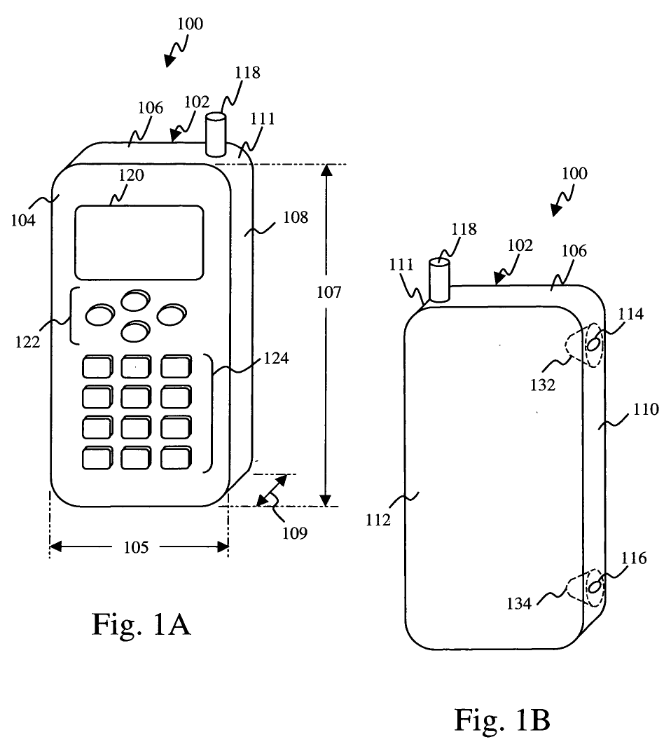

Referring first to FIGS. 1A and 1B, exemplary wireless communication device 100 according to one embodiment of the present invention is shown in front perspective view and rear perspective view, respectively. Although housing 102 of wireless communication device 100 is shown in a traditional one-piece (or “candy-bar”) shape for a mobile phone, the principles and advantages of the arrangement of wireless communication device 100 may also be applied to shapes different from that specifically shown in the Figures and discussed herein.

As shown in FIGS. 1A and 1B, housing 102 of wireless communication device 100 includes front surface 104, top surface 106, first side surface 108 and second side surface 110, where second side surface 110 is situated opposite first side surface 108. Typically, dimension 105 corresponding to the width of front surface 104 is larger than dimension 109 corresponding to the width of first and second side surfaces 108 and 110. Dimension 107, which defines the height of front surface 104 of housing 102, is also typically larger than dimension 109.

Display device 120 and keys 122 and 124 are situated on front surface 104 for interfacing with a user of wireless communication device 100. By way of illustration, display device 120 may be a liquid crystal display (“LCD”) display for displaying text and graphical information to the user, and keys 124 may be used from receiving text and numerical information while keys 122 may be used for receiving commands and/or navigational information from the user.

Antenna 118 is situated proximate first side surface 108 of housing 102. In the particular embodiment shown in FIG. 1A, antenna 118 extends through an opening defined in upper surface 106 proximate edge 111 of housing 102, where edge 111 defines the junction between top surface 106 and first side surface 108. As shown in FIG. 1B, openings 114 and 116 are defined proximate second side surface 110 and opposite first side surface 108. By way of illustration, speaker 132 (shown in dashed lines in FIG. 1B) may be situated within housing 102 for transmitting acoustic signals via opening 114, and microphone 134 (shown in dashed lines in FIG. 1B) may be situated within housing 102 for receiving acoustic signals via opening 116.

During conversational use, second side surface 110 of housing 102 is in contact with or proximate the user's head, while first side surface 108 is situated furthest from the user's head. For example, a user may hold housing 102 such that opening 114 is proximate the user's ear and opening 116 is proximate the user's mouth. Since antenna 118 is arranged proximate first side surface 108 and opposite second side surface 110, the effective distance between the user's head and antenna 118 is significantly increased, which results in significantly reduced EM interference between the user's head and antenna 118. For example, due to the orientation of housing 102 during use, the distance between the user and antenna 118 corresponds generally with dimension 105, rather than smaller dimension 109. Users of hearing aids are also benefited, since the increased distance between the user and antenna 118 also results in reduced hearing aid interference thereby improving hearing aid compatibility. Significantly, little or no additional elements and very little modification of wireless communication device 100 are needed according to the particular embodiment shown in FIGS. 1A and 1B. For example, the particular embodiment shown in FIGS. 1A and 1B can be achieved by relocating openings 114 and 116, speaker 132 and microphone 134 proximate second side surface 110. In other embodiments, wireless communication device 100 may be modified to include additional RF interference-reducing techniques to further reduce EM interference between the user's head and antenna 118.

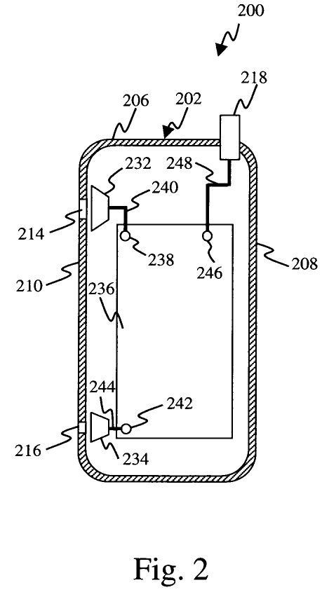

Referring next. to FIG. 2, there is shown a cross-sectional view of housing 202 of wireless communication device 200 taken along a plane intersecting top surface 206, first side surface 208 and second side surface 210 of housing 202. Housing 202 corresponds to one particular embodiment of housing 102 as shown in FIGS. 1A and 1B, wherein PCB 236 is generally coplanar with a front surface (not shown) of housing 202. In FIG. 2, top surface 206, first side surface 208, second side surface 210, first opening 214, second opening 216, antenna 218, speaker 232 and microphone 234 correspond to top surface 106, first side surface 108, second side surface 110, first opening 114, second opening 116, antenna 118, speaker 132 and microphone 134, respectively, in FIG. 1.

PCB 236 includes an interface for communicating with one or more devices. For example, as shown in FIG. 2, contact 238 provides an interface to speaker 232 by way of line 240; contact 242 provides an interface to microphone 234 by way of line 244; and contact 246 provides an interface to antenna 218 by way of line 248. In the arrangement of housing 202, antenna 218 is situated proximate first side surface 208, and openings 214 and 216 are defined proximate second side surface 210 in such a way that openings 214 and 216 and antenna 218 are situated at approximately opposing side surfaces of housing 202. As discussed above, second side surface 210 of housing 202 is in contact with or proximate the user's head during conversational use, while first side surface 208 is situated furthest from the user's head. Such an arrangement increases the effective distance between the user's head and antenna 218 and results in significantly reduced EM interference between the user's head and antenna 218.

Due to the particular arrangement of housing 202, the user's exposure to EM energy originating from PCB 236 or from other devices associated with wireless communication device 200, such as an LCD display device, can also be reduced. In contrast to known arrangements wherein the PCB is generally coplanar with the exposed surface of the user's head proximate the wireless communication device, PCB 236 of wireless communication device 200 lies along a plane which is directed away from, rather than perpendicular to, the user's head during conversational use. Thus, the relative distances between components on PCB 236 and the user's head are substantially increased, particularly for components on PCB 236 proximate first side surface 208. This increased distance achieved by the arrangement of housing 202 results in reduced user exposure to EM energy originating from PCB 236. In a similar way, a reduction in the user's exposure to EM energy from an LCD display device coplanar with PCB 236 is also achieved. As discussed above, hearing aid interference is also substantially reduced. In other embodiments, wireless communication device 200 may be modified to include additional RF interference-reducing techniques to further reduce EM interference between the user's head and antenna 218 and/or PCB 236.

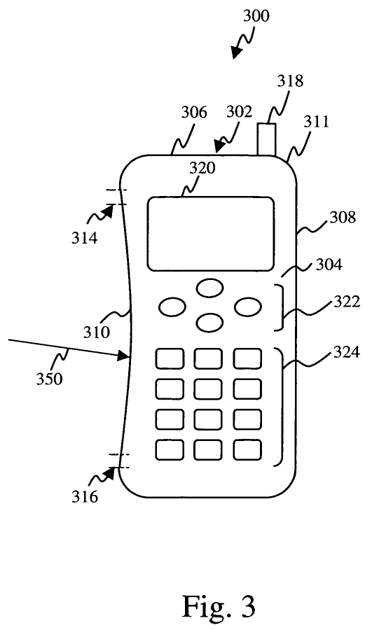

Referring now to FIG. 3, a front elevation view of housing 302 of wireless communication device 300 according to another embodiment of the present invention is shown. Wireless communication device 300 is similar to wireless communication device 100 of FIGS. 1A and 1B, wherein antenna 318 is situated proximate first side surface 308 and openings 214 and 316 (indicated as dashed-lines) associated with a speaker and a microphone, respectively, are situated proximate opposing second side surface 310. Display device 320, and keys 322 and 324 are situated on front surface 304 of housing 302 for interfacing with the user.

As shown in FIG. 3, second side surface 310 of housing 302 is generally concave as indicated by radius 350. This particular arrangement, while achieving the benefits discussed above in conjunction with FIGS. 1A and 1B, additionally improves the ergonomics of the wireless communication device 300 since concave second side surface 310 more closely follows the contour of the user's head as second side surface 310 is placed in contact with or proximate to the user's head during conversational use.

From the above description of exemplary embodiments of the invention, it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. For example, one or more of the benefits of the wireless communication device arrangement according to various embodiments as discussed above may also be realized in other device shapes or form factors, such as hinged (or “clam-shell”) mobile phones, for example. The described exemplary embodiments are to be considered in all respects as illustrative and not restrictive. It should also be understood that the invention is not limited to the particular exemplary embodiments described herein, but is capable of many rearrangements, modifications, and substitutions without departing from the scope of the invention.

1. A communication device comprising:
a housing including a front surface, a first side surface, and a second side surface, the second side surface being situated opposite the first side surface;
an antenna situated proximate the first side surface;
a speaker situated proximate the second side surface; and
a microphone situated proximate the second side surface.

2. The communication device of claim 1 wherein first and second openings are defined proximate the second side surface, the speaker situated within the housing to transmit acoustic signals via the first opening, the microphone situated within the housing to receive acoustic signals via the second opening.

3. The communication device of claim 1 further comprising a printed circuit board situated within the housing, the printed circuit board substantially coplanar with the front surface.

4. The communication device of claim 1 wherein a first dimension defines a width of the front surface and a second dimension defines a width of the second side surface, the second dimension being less than the first dimension.

5. The communication device of claim 1 further comprising a keypad situated on the front surface.

6. The communication device of claim 1 further comprising a display device situated on the front surface.

7. The communication device of claim 1 wherein the second side surface is concave to generally follow a contour of a user's head.

8. A communication device comprising:
a housing including a front surface, a first side surface, and a second side surface, the second side surface being situated opposite the first side surface;
an antenna situated proximate the first side surface;
a speaker opening defined proximate the second side surface;
a microphone opening defined proximate the second side surface;
a speaker situated within the housing to transmit acoustic signals via the speaker opening; and
a microphone situated within the housing to receive acoustic signals via the microphone opening.

9. The communication device of claim 8 further comprising a printed circuit board situated within the housing, the printed circuit board substantially coplanar with the front surface.

10. The communication device of claim 8 wherein a first dimension defines a width of the front surface and a second dimension defines a width of the second side surface, the second dimension being less than the first dimension.

11. The communication device of claim 8 further comprising a keypad situated on the front surface.

12. The communication device of claim 8 further comprising a display device situated on the front surface.

13. The communication device of claim 8 wherein the second side surface is concave to generally follow a contour of a user's head.

14. A wireless communication device comprising:
a housing including a front surface, a first side surface, and a second side surface, the second side surface being situated opposite the first side surface;
an antenna situated proximate the first side surface;
a transceiver coupled to the antenna and disposed within the housing, the transceiver configured to transmit and receive an RF signal;
a mobile power source coupled to the transceiver for supplying power to the transceiver;
a speaker situated proximate the second side surface; and
a microphone situated proximate the second side surface.

15. The wireless communication device of claim 14 wherein first and second openings are defined proximate the second side surface, the speaker situated within the housing to transmit acoustic signals via the first opening, the microphone situated within the housing to receive acoustic signals via the second opening.

16. The wireless communication device of claim 14 further comprising a printed circuit board situated within the housing, the printed circuit board substantially coplanar with the front surface.

17. The wireless communication device of claim 14 wherein a first dimension defines a width of the front surface and a second dimension defines a width of the second side surface, the second dimension being less than the first dimension.

18. The wireless communication device of claim 14 further comprising a keypad situated on the front surface.

19. The wireless communication device of claim 14 further comprising a display device situated on the front surface.

20. The wireless communication device of claim 14 wherein the second side surface is concave to generally follow a contour of a user's head.
